(19) United States
(12) Patent Application Publication
(10) Pub. No.: US 2014/0263799 A1
(43) Pub. Date: Sep. 18, 2014

(54) Retractor Mechanism For Collars

(71) Applicant: Advanced Practical Products, LLC, Santa Monica, CA (US)

(72) Inventors: David Francis Baerwald, Los Angeles, CA (US); Mark A. Presser, Los Angeles, CA (US); Neal B. Rosenblum, Hollywood, FL (US)

(21) Appl. No.: 14/209,918

(22) Filed: Mar. 13, 2014

Related U.S. Application Data
(60) Provisional application No. 61/798,294, filed on Mar. 15, 2013.

(51) Int. Cl. A01K 27/00

(52) U.S. Cl. CPC A01K 27/004
USPC 242/381.5

(57) ABSTRACT

A retractor mechanism for a pet collar. The mechanism includes a case with a cavity, a spool assembly with a spool plate, a line wound on the spool assembly with a free end exiting the case that is attached to a leash handle, a power spring that biases the spool assembly to a wound state, and a centrifugal/inertial brake having with a lock member with a heavier distal end a lighter proximal end, and lock member spring. The lock member pivots on the spool plate. When the spool assembly is spun above a threshold rotations speed, a centripetal force acting on the distal end of the lock member exceeds a spring force of the lock member spring acting on the proximal end of the lock member, thereby pivoting the lock member into contact with a catch in the cavity of the case to prevent the spool assembly from rotating further.

### CROSS REFERENCE TO RELATED APPLICATIONS

This application claims priority from U.S. Provisional Patent Application No. 61/798,294, filed on Mar. 15, 2013, entitled RETRACTOR MECHANISM FOR COLLARS”

### BACKGROUND OF THE INVENTION

The present invention relates generally to retractor mechanisms, and more particularly to a retractor mechanism adapted to be incorporated into a collar for pets. However, this retractor mechanism can be used in other applications as well.

Pet ownership in the U.S. is broad and wide. There are more than 150 million dogs and cats owned in the U.S. In the case of dogs, most dogs wear collars and when taken on walks, are generally walked with leashes or leads connected to the collars.

Many veterinarians and dog trainers recommend that dogs be walked on a leash or lead that is relatively short, e.g., three to four feet, so that the dog will become accustomed to walking close to the owner. However, many pet owners instead believe that their pets should be free to roam wide and far and therefore use hand held retracting leashes that allows their dog to move in a large area around the pet owner. These devices generally include springs that retract the leash back into the hand held retracting leash case. Many of these retracting leashes include manual brakes so the operator can control the working length of the leash. Some of these retracting leashes include automatically operated brakes that are activated when the leash is pulled out a rapid rate, thereby preventing the leash from being pulled out further and possibly damaging the unit or causing jamming. These retracting leashes are generally large and include a grip portion, a case with complex gearing in which a long and stout cable or leash ribbon is wound, and they are designed for heavy duty use. The relative complexities of these retracting leashes do not lend themselves to miniaturization.

The patent literature also disclosures collars that incorporate retractable leashes. Some of these devices include a lock so that a working length of leash withdrawn from the retractor device can be set. A few designs contain braking devices. However, these leash mounted devices are of a cumbersome design, are excessively large, and would not be expected to be sturdy and reliable enough to withstand the pulling and jerking acting on collars connected to leads or leashes. Therefore, there exists a need for a retractor mechanism for a pet collar that is small in size, simple in construction, lightweight, and reliable in operation.

### SUMMARY OF THE INVENTION

The invention provides a retractor mechanism for a pet collar. It comprises: a case including a cavity, and having a line egress; a spool assembly with a spool plate rotatably positioned in the cavity; a line having a fixed end and a free end, the line being wound on the spool assembly and affixed at the fixed end to the spool assembly, with the free end extending from the line egress in the case; a power spring engaged with the spool assembly and the case, which power spring biases the spool assembly and the line to a wound state; a centrifugal/inertial brake having a lock member and lock member spring, the lock member having a distal lock end, a proximal end, and a pivot for pivotally engaging the lock member to the spool plate, the lock member being biased by the lock member spring to a unlocked position wherein the distal lock end is pivoted inwardly into the spool plate, and movable to a locked position where the distal lock end pivots outwardly where it impinges on the case and prevents further rotation of the spool assembly, wherein the unlocked position is maintained when the spool assembly are either not rotating or not rotating above a threshold rotational speed and wherein if the spool assembly is rotated above the threshold rotational speed then a biasing force of the spring acting on the lock member is overcome and the distal lock end of the lock member pivots to its locked position.

The invention further provides a retractor mechanism for a pet collar. It comprises: a case including a cavity with a catch formed in the cavity, and having a line egress; a lock switch that is switchable between a unlocked position, and a locked position, the lock switch having a lock detent; a spool assembly with a gear, the gear having gear teeth for capture by the lock detent of the lock switch; a spool plate that is located adjacent to the spool assembly and engages therewith, the spool assembly and spool plate being rotatably located in the cavity; a line having a fixed end and a free end, the line being wound on the spool assembly and affixed at the fixed end to the spool assembly, with the free end extending from the line egress in the case; a power spring engaged with the spool assembly and the case, which power spring biases the spool assembly and the line to a wound state; a centrifugal/inertial brake having a lock member and lock member spring, the lock member having a distal lock end, a proximal end, and a pivot for pivotally engaging the lock member to the spool plate, the lock member being biased by the lock member spring to a unlocked position wherein the distal lock end is pivoted inwardly into the spool plate, and movable to a locked position where the distal lock end pivots outwardly where it impinges on the catch of the case and prevents further rotation of the spool plate and the attached spool assembly, wherein the unlocked position is maintained when the spool plate and the connected spool assembly are either not rotating or not rotating above a threshold rotational speed and wherein if the spool plate and its connected spool assembly are rotated above the threshold rotational speed then a biasing force of the spring acting on the lock member is overcome and the distal lock end of the lock member pivots to its locked position.

### BRIEF DESCRIPTION OF THE DRAWINGS

FIG. 1 is a front isometric view of an exemplary embodiment of a retractor mechanism of the invention and an optional leash handle

FIG. 2 is a rear view of the exemplary embodiment of the retractor mechanism of FIG. 1.

FIG. 3 is an exposed side isometric view of internal components of the exemplary embodiment of the retractor mechanism of FIG. 1.

FIG. 4 is an exposed side view of the internal components of the exemplary embodiment of the retractor mechanism of FIG. 1.

FIG. 5 is an exposed front view of internal components of the exemplary embodiment of the retractor mechanism of FIG. 1 with the back cover shown and the front cover removed.

FIG. 6 front isometric rear view of selective portions of the exemplary embodiment of the retractor mechanism of FIG. 1 with the back cover shown and the front cover removed.

FIG. 7 is a rear plan view of the exemplary embodiment of the retractor mechanism of FIG. 1 with a back cover removed to reveal internal components, and with the rocker switch in a locked position.

FIG. 8 is a rear isometric view of the exemplary embodiment of the retractor mechanism of FIG. 7.

FIG. 9 is a rear plan view of the exemplary embodiment of the retractor mechanism of FIG. 1 with a back cover removed to reveal the internal components, and with the rocker switch in an unlocked position.

FIG. 10 is a rear isometric view of the exemplary embodiment of the retractor mechanism of FIG. 9.

FIG. 11 is a left end view of the exemplary embodiment of the assembled retractor mechanism of FIG. 1.

FIG. 12 a cross-sectional view of the exemplary embodiment of the assembled retractor mechanism of FIG. 1 along view lines 12-12 of FIG. 11.

FIG. 13 is a cross-sectional view of the exemplary embodiment of the assembled retractor mechanism of FIG. 1 along view lines 13/14-13/14 of FIG. 11, with the lock members in unlocked positions.

FIG. 14 is a cross-sectional view of the exemplary embodiment of the assembled retractor mechanism of FIG. 1 along view lines 13/14-13/14 of FIG. 11, but with the lock members in locked positions.

### DETAILED DESCRIPTION

FIG. 1 is a front isometric view of an exemplary embodiment of the retractor mechanism 10 of the invention and FIG. 2 is a rear view thereof. The retractor mechanism 10 has a case portion 12 with side brackets 14 at opposite ends, each having attachment bars 16 that can be used to connect the retractor mechanism 10 to a collar (not shown.) The case portion 12 has a case front 18 and sides 20. A lock switch 22 extends through an opening 24 in one side 20, and a line 26, such as a cable or strap, extends from an opening 28 formed on another side 20. The line 26 has a free end 60 that can be attached to a hand grip or other structure such as a leash handle 62 (shown in FIG. 1) A rear cover 30 fits on the back of the case 12. It is shown attached there by screws 32, but it can be attached by other mechanism devices, by adhesive, by sonic welding, or other known means. Furthermore, the shape of the case portion 12 and it brackets 14 with attachment bars 16 can be modified depending on the precise application without changing the main features of the invention. Indeed, depending on the form factor desired, the case 12 can have any other shape and include means other than attachment bars for use in attaching the case 12 to other structures such collars. Furthermore, while the line 26 is shown exiting through the opening 28 on a side 20 that is opposite the side 20 with the lock switch 22, the opening 28 and line 26 can exit at other positions on the case.

FIG. 3 is an exposed side isometric view of internal components of the exemplary embodiment of the retractor mechanism 10 of FIG. 1. FIG. 4 is an exposed side view, FIG. 5 is an exposed back view, and FIG. 6 is a front isometric rear view of selective components of the exemplary embodiment of the retractor mechanism 10 of FIG. 1 with the rear cover shown but the case portion 12 removed. The screws 32 are shown. The lock switch 22 that is switchable between an unlocked position (not shown), and a locked position (see FIG. 5). The lock switch 22 has two lobes 40A and 40B, and depending on which protrudes more from the case, this will indicate to a user whether the lock switch 22 is in the unlocked position or the locked position. A lock switch pivot 42 is provided to allow the lock switch 22 to move between the locked and unlocked positions. Lobe 40B has a lock detent 44 which is adapted to engage with gear teeth 46 of a gear 48 on a spool assembly 50 when the lock switch 22 is in its locked position. A spool plate 52 is located adjacent to the spool assembly 50 and non-rotatably engages therewith. Preferably, the spool plate 52 will seat on the spool assembly 50 to retain the wound line 26 therein. This can be accomplished by the spool plate 52 having a non-round opening 54 formed through a center thereof, which will engage with a spindle 56 of the spool assembly 50. A switch spring 58 (which can be in the form of a leaf spring) will bear on the lock switch 22 and keep it in one of the locked and unlocked position unless a user manually moved the lock switch 22 the other position. However, other types of biases mechanisms can be used in lieu of leaf springs. The line 26 has a fixed end (not shown) and a free end 60, and the line 26 is wound on the spool assembly 50 and affixed at its fixed end to the spool assembly 50, with the free end 60 extending from the line egress in the case (not shown). A pin 70 can be used to rotatably retain the spool assembly 50 and spool plate 56 and the wound line 26 in the case. A centrifugal/inertial brake mechanism 64 is provided and includes at least one, and preferably a plurality of lock members 72 and lock member spring 74. Each lock member 72 has a distal lock end 76, a proximal end 78, and a pivot 80 between the distal lock end 76 and the proximal end 78 for pivotally engaging the lock members 72 to the spool plate 52. The lock members 72 are shown as being generally L-shaped but can have other shapes so that preferably the majority of the mass of the lock members is at the distal lock ends 76. Thus, when the spool plate 52 is rotated above a certain angular speed such that the turning force exerted on the distal lock end 76 of each lock member 72 exceeds the counteracting force provided by the spring 74, the distal lock ends of the lock members 72 will pivot outwardly. The spool plate 52 has spring retainers 82 that extend upwardly from a glide surface 84 upon which are placed the lock members 72. The spring retainers 82 can extend from lock member retainers 86, which prevent the lock members 72 from pivoting further counter-clockwise from the position of the lock members 72 shown in FIGS. 5 and 6.

Referring to FIG. 7, there is shown a rear plan view of the exemplary embodiment of the retractor mechanism 10 of FIG. 1 with its back cover removed to reveal certain components, and FIG. 8 is a rear isometric view of the exemplary embodiment of the retractor mechanism 10 of FIG. 7 thereof. The rocker switch 22 is shown extending from the opening 24 in one side 20 of the case 12, and in a locked position with its lock detent 44 locked between two gear teeth 46 of the gear 48 and with its lobe 40A in the upward position and its lobe 40B in the downward position. The switch spring 58 is also shown. The rocker switch 22 is shown pivoted on the lock switch pivot 42. A power spring 90 is used to rewind the spool assembly 50 and line 26 back into the retractor mechanism 10. The power spring 90 has an inner end 92 which engages with a slot 94 on a spool hub 96. An outer end 98 of the power spring 90 will engage with the case 12 and retain the power spring 90. The case portion 12 has a cavity 100 formed therein in which fits the various other components. The dowel pin 70 is also shown and allows rotation of the spool assembly 50, the spool plate 52 and is carried line 26. On the case portion 12 on the side 20 adjacent to the lock switch 20, a locked symbol 102 and unlocked symbol 104 can be located adjacent to the lobes 40B and 40A, respectively, to provide a visual indication to the user of whether the device is locked or unlocked.

FIG. 9 is a rear plan view of the exemplary embodiment of the retractor mechanism of FIG. 1 with a back cover removed to reveal the certain components, and with the rocker switch in an unlocked position, and FIG. 10 is a rear isometric view of the exemplary embodiment of the retractor mechanism of FIG. 9. FIGS. 9 and 10 are identical to FIGS. 7 and 8, respectively, except that the lock switch 22 is in the unlocked position where the lock detent 44 is moved away from the gear teeth 46 so that the spool assembly may otherwise turn, unless the centrifugal/inertial brake mechanism 64 is activated, as will be discussed further below.

FIG. 11 is end view of the exemplary embodiment of the assembled retractor mechanism 10 of FIG. 1. The case portion 12, side brackets 14, attachment bars 16, case front 18, sides 20, lock switch 22, line 26, line opening 28, and unlocked symbol 104 on the side 20 are shown.

FIG. 12 a cross-sectional view of the exemplary embodiment of the assembled retractor mechanism of FIG. 1 along view lines 12-12 of FIG. 11. The case portion 12 with its case front 18 and rear cover 30 enclose the pin 70 upon which rotates the spool assembly 50 with its spindle 56, spool plate 52 and the carried line 26. Also contained in the case portion 12 are the lock members 72, pivots 80, lock member springs (not shown), and the power spring 90. The lock switch pivot 42 and switch spring 58 are shown, as well as the opening 28 from which exists the line 26. The opening 28 can comprise a grommet 112 with a curved opening 114, which grommet 112 can be formed of a low friction material. The grommet 112 in turn fits into an opening 116 the case portion 12. A cavity 100 of the case 12 is shown, along with catches 110 formed in the cavity 100 of the case portion 12.

FIG. 13 is a cross-sectional view of the exemplary embodiment of the assembled retractor mechanism 10 along view lines 13/14-13/14 of FIG. 11, with the lock members 72 in unlocked positions, and FIG. 14 is a same view, but with the lock members 72 in their locked positions. The lock members 72 of the centrifugal/inertial brake mechanism 64 are pivotally positioned on the spool plate 52 by pivots 80, and are biased by the lock member springs 74 to a first unlocked position shown in FIG. 13, wherein the distal lock ends 76 is pivoted inwardly, and movable to a second locked position shown in FIG. 14 where the distal lock ends 76 are pivoted outwardly where they impinges on catches 110 with ends 120 formed in the cavity 100 of the case portion 12 to prevent further rotation of the spool plate 52 and the attached spool assembly 50. The lock member springs 74 are positioned between spring retainers 82 and bear on the proximal ends 78 of the lock members 72, wherein the first unlocked position is maintained when the spool plate 52 and the connected spool assembly 50 are either not rotating or not rotating above a threshold rotational speed. However, if the spool plate 52 and its connected spool assembly 50 are rotating or accelerated above the threshold rotational speed, due to centrifugal forces action on the lock member 72, such as would occur if the line 26 is pulled or yanked rapidly, then a biasing force of the lock member spring 74 acting on the lock members 72 is overcome and the distal lock end 76 of the lock member 72 will pivot outwardly to its second locked position and engage with the catches 110 and impinge on the ends 120 thereof, and thereby prevent further rotation of the spool assembly 50 and further withdrawal of the line 26. However, upon release of the tension on the line 26, the lock members 72 will return to their unlocked positions shown in FIG. 13, and the line 26 can move into or out of the case portion 12.

The case and internal components can be formed of desired materials, such as plastic, metal, or other known materials. In order to provide a strong yet lightweight device, the line 26 should be made of strong and resilient material. The inventor has found that ultra high molecular weight polyethylene, such as offered by DSM High Performance Fibers B.V., under the trademarked name Dyneema®, functions well for the line. While the term “line” has been used, in a preferred embodiment of the invention the line will be around cable, although the line could be selected to have other cross-sections, and could be in the form of a tape, strap, etc.

The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. Indeed, the shape of the case portion 12, shape and position of lock switch 22 can be modified as desired. The line will preferably have a leash handle located at a terminal end thereof, and the leash handle can have detachable attachments (including but not limited to hook and loop or hook and hook material, snaps, clasps, magnetics) for detachably connecting the leash handle to a collar. However, in other applications other devices can be connected or connectable to the line as desired. Moreover, if a user wishes to have an embodiment of the retractor mechanism that clips onto another device, a hook, clip, or other feature can be used instead of two side brackets and attachment bars. For example, such an embodiment would allow a convention collar to be retrofitted to be used with the retractor mechanism of the invention.

What is claimed is:

1. A retractor mechanism for a pet collar, comprising:
a case including a cavity, and having a line egress;
a spool assembly with a spool plate rotatably positioned in the cavity;
a line having a fixed end and a free end, the line being wound on the spool assembly and affixed at the fixed end to the spool assembly, with the free end extending from the line egress in the case;
a power spring engaged with the spool assembly and the case, which power spring biases the spool assembly and the line to a wound state;
a centrifugal/inertial brake having a lock member and lock member spring, the lock member having a distal lock end, a proximal end, and a pivot for pivotally engaging the lock member to the spool plate, the lock member being biased by the lock member spring to a unlocked position wherein the distal lock end is pivoted inwardly into the spool plate, and movable to a locked position where the distal lock end pivots outwardly where it impinges on the case and prevents further rotation of the spool assembly, wherein the unlocked position is maintained when the spool assembly are either not rotating or not rotating above a threshold rotational speed and wherein if the spool assembly is rotated above the threshold rotational speed then a biasing force of the spring acting on the lock member is overcome and the distal lock end of the lock member pivots to its locked position.

2. The retractor mechanism for a pet collar of claim 1, further comprising a lock switch with a lock detent, the lock switch being switchable between a unlocked position and a locked position, wherein the spool assembly further comprises a gear, the gear have gear teeth which are captured by the lock detent of the lock switch when the lock switch is in the locked position, which locked position locks the spool assembly in place and prevents the line from being further retracted from the case.

3. The retractor mechanism for a pet collar of claim 2, wherein the lock switch further comprises a leaf spring to maintain the position of the lock switch in one of the unlocked and locked position.

4. The retractor mechanism for a pet collar of claim 1, further comprising a catch formed on an inside of the cavity of the case, which catch captures the distal end of the lock member when the lock member is in its locked position.

5. The retractor mechanism for a pet collar of claim 1, wherein the spool assembly comprises a non-round shaft and the spool plate has a complementary opening formed therethrough with the spool plate non-rotatably seating on the spool assembly, and wherein the spool plate includes a stop against which rides the lock member spring.

6. The retractor mechanism for a pet collar of claim 1, wherein the spool plate is separate from but located adjacent to the spool assembly and non-rotatably engages therewith.

7. The retractor mechanism for a pet collar of claim 1, wherein the case further comprises attachment bars.

8. The retractor mechanism for a pet collar of claim 1, further comprising a leash handle that attaches to the free end of the line.

9. The retractor mechanism for a pet collar of claim 1, wherein the line comprises ultra high molecular weight polyethylene material.

10. The retractor mechanism for a pet collar of claim 4, wherein a plurality of lock members and lock member springs and a plurality of catches are provided.

11. The retractor mechanism for a pet collar of claim 1, wherein the lock member is generally L-shaped, with the pivot located at a transition between the distal lock end and the proximal end, and wherein the distal lock end has more mass than the proximal end, and wherein the lock member spring impinges on the proximal end to bias it to the locked position, wherein when the spool plate is rotated above the threshold speed, a centripetal force acting on the distal lock end of the lock member will be in excess of the biasing force of the spring acting on the proximal end and the centripetal force will pivot the lock member so that its distal end impinges on the case.

12. A retractor mechanism for a pet collar, comprising:
a case including a cavity with a catch formed in the cavity, and having a line egress;
a lock switch that is switchable between an unlocked position, and a locked position, the lock switch having a lock detent;
a spool assembly with a gear, the gear having gear teeth for capture by the lock detent of the lock switch;
a spool plate that is located adjacent to the spool assembly and engages therewith, the spool assembly and spool plate being rotatably located in the cavity;
a line having a fixed end and a free end, the line being wound on the spool assembly and affixed at the fixed end to the spool assembly, with the free end extending from the line egress in the case;
a power spring engaged with the spool assembly and the case, which power spring biases the spool assembly and the line to a wound state;
a centrifugal/inertial brake having a lock member and lock member spring, the lock member having a distal lock end, a proximal end, and a pivot for pivotally engaging the lock member to the spool plate, the lock member being biased by the lock member spring to a unlocked position wherein the distal lock end is pivoted inwardly into the spool plate, and movable to a locked position where the distal lock end pivots outwardly where it impinges on the catch of the case and prevents further rotation of the spool plate and the attached spool assembly, wherein the unlocked position is maintained when the spool plate and the connected spool assembly are either not rotating or not rotating above a threshold rotational speed and wherein if the spool plate and its connected spool assembly are rotated above the threshold rotational speed then a biasing force of the spring acting on the lock member is overcome and the distal lock end of the lock member pivots to its locked position.

13. The retractor mechanism for a pet collar of claim 12, wherein the lock switch further comprises a tension leaf spring to maintain the position of the lock switch in one of the unlocked and locked position.

14. The retractor mechanism for a pet collar of claim 12, wherein a plurality of lock members and lock member springs and a plurality of catches are provided.

15. The retractor mechanism for a pet collar of claim 14, wherein each lock member is generally L-shaped, with the pivot located at a transition between the distal lock end and the proximal end, and wherein the distal lock end has more mass than the proximal end, and wherein the lock member spring impinges on the proximal end to bias it to the locked position, wherein when the spool plate is rotated above the threshold speed, a centripetal force acting on the distal lock ends of the lock members will be in excess of the biasing force of the spring acting on the proximal ends and the centripetal force will pivot the lock members so that their distal end impinges on the case.

16. The retractor mechanism for a pet collar of claim 12, wherein the spool assembly comprises a non-round shaft and the spool plate has a complementary opening formed therethrough with the spool plate non-rotatably seating on the spool assembly, and wherein the spool plate includes a stop against which rides the lock member spring.

17. The retractor mechanism for a pet collar of claim 12, wherein the case further comprises attachment bars for affixing the retractor mechanism to a pet collar.

18. The retractor mechanism for a pet collar of claim 12, further comprising a leash handle that extends attaches to the free end of the line.

19. The retractor mechanism for a pet collar of claim 12, wherein the cable line comprises ultra high molecular weight polyethylene material.

20. The retractor mechanism for a pet collar of claim 12, wherein the spool plate is integral with the spool assembly.
